(19) United States
(12) Patent Application Publication
(10) Pub. No.: US 2026/0277855 A1
(43) Pub. Date: Sep. 17, 2026

(54) AUTOMATIC HANDLING OF LOOSELY-COUPLED OBJECTS DURING DATABASE EXPORT AND IMPORT

(71) Applicant: SAP SE, Walldorf (DE)

(72) Inventors: Boyang Zhang, Xi'an (CN); Yinghua Ouyang, Xi'an (CN)

(21) Appl. No.: 19/081,000

(22) Filed: Mar. 17, 2025

(51) Int. Cl. G06F 16/11; G06F 21/62

(52) U.S. Cl. CPC G06F 16/119; G06F 21/6218

(57) ABSTRACT

Methods, systems, and computer-readable storage media for automatic handling of loosely-coupled objects during database export and import. An example method includes adding a target object identified for an export operation of a source database system to an export object list. Target objects are determined that are related to a loosely-coupled object that is not explicitly linked to the target object in a definition of the target object. Information for the related objects and the loosely-coupled object is added to the export object list with a flag that indicates that the loosely-coupled object is a loosely-coupled object type. An export file is generated based on the export object list and is provided to a target database system for importing the export file into the target database system.

### BACKGROUND

Different database systems can support data export and data import functions. Data can be exported, for example, using an export function of a first database instance. The data export can be stored in an export file, for example. A second, different database instance can invoke an import function to import data from the export file into the second database instance. Accordingly, data export and import can be a useful feature for migrating data from one database instance to another database instance.

### SUMMARY

Implementations of the present disclosure are directed to automatic handling of loosely-coupled objects during database export and import. In some implementations, actions include: adding a target object identified for an export operation of a source database system to an export object list; identifying related objects that are each related to the target object, wherein identifying the related objects includes: determining, based on metadata of the source database system, that the target object is related to a loosely-coupled object that is not explicitly linked to the target object in a definition of the target object; and identifying loosely-coupled object information for the loosely-coupled object; adding information for the related objects to the export object list, including adding the loosely-coupled object information to the export object list with a flag that indicates that the loosely-coupled object is a loosely-coupled object type; generating an export file based on the export object list; and providing the export file to a target database system for importing the export file into the target database system.

Other implementations of this aspect include corresponding systems, apparatus, and computer programs, configured to perform the actions of the methods, encoded on computer storage devices.

These and other implementations can each optionally include one or more of the following features. The target object can be a database view and the loosely-coupled object can be a structured filter that provides row-level security for the database view. Determining, based on the metadata of the source database system, that the target object is related to the loosely-coupled object can include querying a structured filters system table of the source database system to determine that the structured filter is related to the target object. Determining the loosely-coupled object information can include: determining that a filter type of a structured filters condition of the structured filter is a dynamic type; identifying a condition provider procedure related to the structured filter; collecting condition provider procedure information for the condition provider procedure; and including the condition provider procedure information in the loosely-coupled object information. Collecting condition provider procedure information for the condition provider procedure can include collecting object information for related objects of the condition provider procedure and including the object information for the related objects of the condition provider procedure in the loosely-coupled object information. Determining the loosely-coupled object information can include: determining that a filter type of a structured filters condition of the structured filter is a static type; and including static condition information for the structured filter in the loosely-coupled object information. The related objects can include a tightly-coupled object that is explicitly linked to the target object in the definition of the target object. The information for the related objects can include database statements for creating the related objects in the target database system. The export file can include information for other target objects other than the target object. The method can include: receiving, at the target database system, the export file; generating an object import list based on the export file, wherein generating the object import list comprises: identifying the target object in the export file; gathering related object information for the target object, including identifying the loosely-coupled object as a related object of the target object; identifying, in the export file, the flag that indicates that the loosely-coupled object is a loosely-coupled object type; and based on identifying the flag, extracting the loosely-coupled object information for the loosely-coupled object and objects related to the loosely-coupled object. The method can include executing a database import at the target database system using information in the object import list. Executing the database import can include executing database commands, in a dependency order, in the target database system, to create objects related to the loosely-coupled object, the loosely-coupled object, and the target object. The method can include deleting, in the target database system, before executing the database commands, any existing conflicting objects that conflict with the target object or related objects of the target object.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIGS. 2-3 illustrate example database code.

FIG. 4 depicts an example process that can be executed in accordance with implementations of the present disclosure.

FIGS. 5A-5B illustrate example query results.

FIG. 6 depicts an example process that can be executed in accordance with implementations of the present disclosure.

FIG. 7 depicts an example system that can be used to execute implementations of the present disclosure.

FIG. 8 depicts an example process that can be executed in accordance with implementations of the present disclosure.

FIG. 9 is a schematic illustration of example computer systems that can be used to execute implementations of the present disclosure.

Like reference symbols in the various drawings indicate like elements.

### DETAILED DESCRIPTION

Implementations of the present disclosure are directed to automatic handling of loosely-coupled objects during database export and import. During a database export operation for an object, a source database system can collect related objects that are related to the object and upon which the object depends. Exported objects can be imported during an import operation, such as into a target database system during a migration process. Collecting related objects can enable the related objects to be imported during the import operation along with the object so that the target database system has all objects involved in object relationships with the object.

Related objects can be related to the object in different ways. For example, some related objects may be considered to be tightly-coupled objects that are tightly coupled to the object, such as by explicit references. For instance, a definition of the object (e.g., a code statement that is used to define or create the object) can include an explicit reference to a related object. For example, a view object definition can explicitly refer to a table object upon which the view object depends.

Other related objects may be considered to be loosely-coupled objects in that a related object may be related to an object without an explicit linking of the two objects in an object definition of the object. For instance, a view may be protected by a structured filter object, but a view definition of the view might not explicitly specify which structured filter object is associated with the view. An association between the view and a structured filter may be established and identified in other ways, as described below. A view therefore may be considered to be loosely coupled to an associated structured filter object. A default implementation of the source database system might not include features for collecting loosely-coupled objects during a database export.

However, when a view object is exported, the source database system can use a solution described below to collect related loosely-coupled objects to ensure, for example, data integrity and correct access control in the target database system to which such objects are imported. For example, the solution includes a method for efficiently exporting and importing loosely-coupled objects such as structured filters. During exporting, the source database system can identify a base list of objects to be exported that includes a target object to be exported and its related objects using a recursive process.

For loosely-coupled objects such as a structured filter, the source database system can query metadata such as an internal system view (e.g., with a predefined name of “STRUCTURED_FILTERS”) to retrieve detailed metadata about a structured filter such as a restriction type, a filter type, and operand attributes. The source database system can evaluate the metadata to establish a relationship between the structured filter and the target object. Related objects used by the loosely-coupled object can be sequentially added by the source database system (e.g., to maintain dependency order) to the base list of objects to be exported. After the base list of objects is generated, the source database system can generate export query statements for each exported object that are configured to be executed in the target database system to trigger the creation of the exported object and its related objects in the target database system.

During importing in the target database system, the target database system can initialize configuration parameters and validate an import path. The target database system can assess a feasibility of an import operation by verifying the dependencies of target objects to ensure all requirements are met in an export file received at the target database system. The target database system can, in some cases, remove existing related objects that are related to any objects in the export file to prepare for the importation of new objects. The target database system can execute, in dependence order, query statements generated during the export phase to create exported objects in the target database system. If a target object is identified as being related to a loosely-coupled object such as a structured filter, an import process for the loosely-coupled object is performed, as described below, so that the loosely-coupled object and any related objects are imported together.

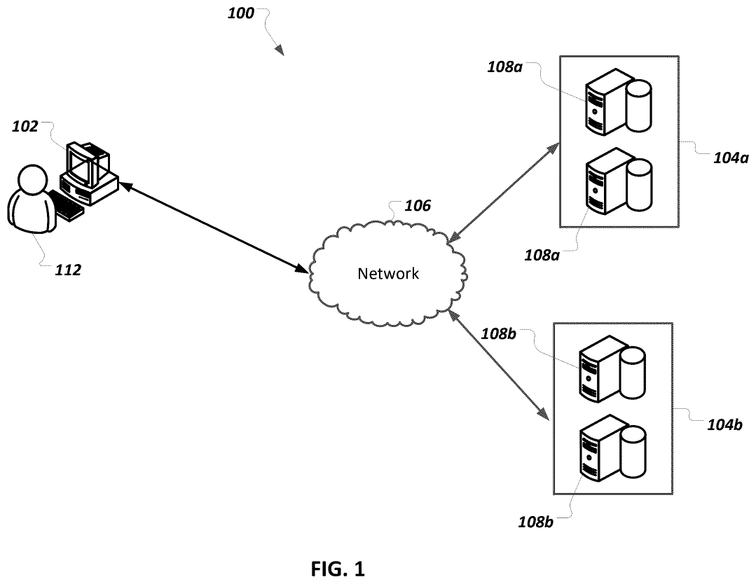

FIG. 1 depicts an example architecture 100 in accordance with implementations of the present disclosure. In the depicted example, the example architecture 100 includes a client device 102, a network 106, a server system 104a and a server system 104b. Each server system 104a and 104b includes one or more server devices and databases 108a or 108b, respectively (e.g., processors, memory). In the depicted example, a user 112 interacts with the client device 102.

In some examples, the client device 102 can communicate with the server system 104a and/or the server system 104b over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104a and the server system 104b each include at least one server and at least one data store. In the example of FIG. 1, the server system 104a and the server system 104b are intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104a and the server system 104b can each be a relational database system or can otherwise include a relational database. In some examples, the user 112 is an administrator, the client device 102 is an administrator device, and the user 112 uses the client device 102 to trigger a database export operation on the server system 104a and a corresponding import operation on the server system 104b. The export operation can include generation of an export file by the server system 104a that includes information about exported database objects. The import operation can include the server system 104b loading the export file and using the export file during the import operation, to cause creation of database objects in the server system 104b in accordance with contents of the export file. As described below, the export and import operations can respectively include exporting or importing of objects that relate to objects targeted for export, where the related objects can include tightly-coupled and/or loosely-coupled objects.

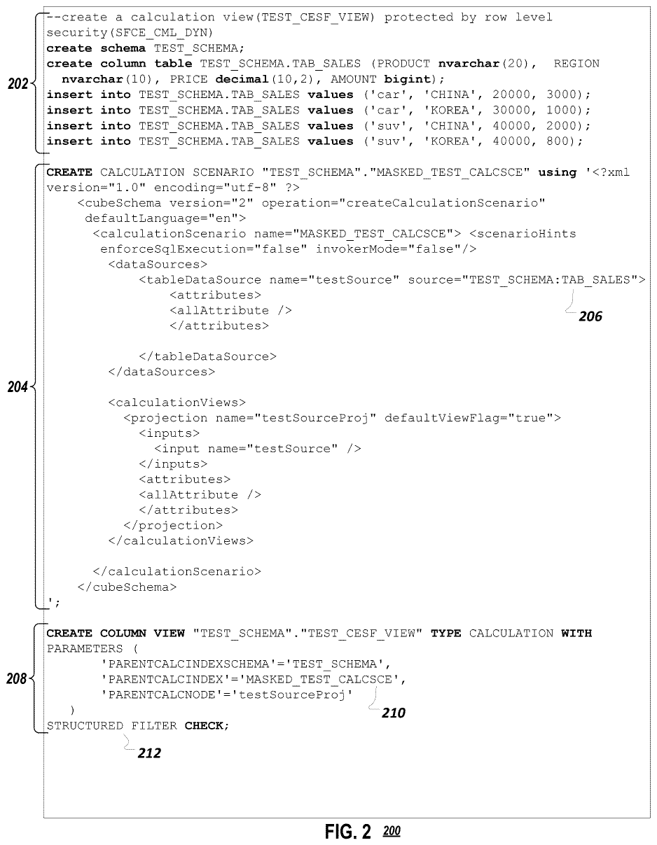

FIG. 2 illustrates example database code 200. Code statements 202 can be executed by a database system to create an example table object named TAB_SALES in a TEST_SCHEMA schema. A create calculation statement 204 can be executed by the database system to create a calculation object named MASKED_TEST_CALCSCE. The create calculation statement 204 explicitly links the MASKED_TEST_CALCSCE calculation object to the TAB_SALES table object by including a TAB_SALES reference 206 in the create calculation statement 204. Accordingly, the MASKED_TEST_CACSCE calculation object can be considered as a dependent object of the TAB_SALES object. The MASKED_TEST_CACSCE calculation object may also be considered a tightly-coupled object due to the explicit reference to the TAB_SALES object IN the create calculation statement 204.

A create view statement 208 can be executed by the database system to create a view object named TEST_CESF_VIEW. The create view statement 208 explicitly links the TEST_CESF_VIEW object to the MASKED_TEST_CACSCE calculation object by including a MASKED_TEST_CALCSCE reference 210 in the create view statement 208. Accordingly, the TEST_CESF_VIEW object can be considered as a dependent object of and tightly-coupled to the MASKED_TEST_CACSCE calculation object. The TEST_CESF_VIEW object can also be considered as an indirect dependent object of the TAB_SALES table object based on a dependency chain that links the TEST_CESF_VIEW object, the MASKED_TEST_CACSCE calculation object, and the TAB_SALES object. During a database export that includes, for example, the TAB_SALES object, the dependent objects MASKED_TEST_CACSCE and TEST_CESF_VIEW can be identified and exported, based on explicitly-defined relationships.

A structured filter check clause 212 in the create view statement 208 indicates that the view may be defined by row-level security using a structured filter. However, the create view statement 208 does not indicate which structured filters may be used to provide the row-level security. Structured filters used for the view may be considered as dependent but loosely-coupled objects to the view (e.g., since the create view statement 208 does not explicitly specify specific structured filter objects). When importing the TEST_CESF_VIEW object, structured filter information used for the view should also be exported, but such exporting can't rely on explicitly defined links or references included in the create view statement 208. Rather, as described in more detail herein, export (and corresponding import) operations can use a metadata-based approach to export or import loosely-coupled objects, respectively.

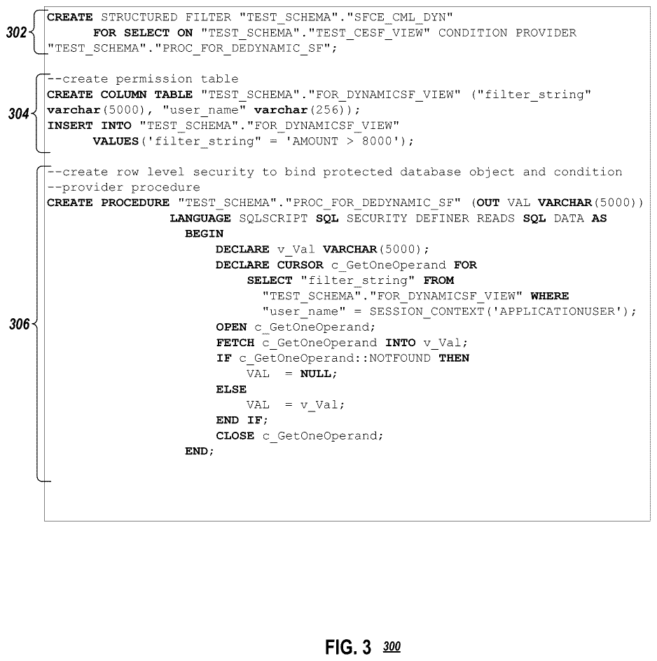

FIG. 3 illustrates example database code 300. A code statement 302 can be executed by a database system to create a structured filter named SFCE_CML_DYN in a schema named TEST_SCHEMA. A code statement 304 can be executed by the database system to create a FOR_DYNAMICSF_VIEW permission table for the structured filter. A code statement 306 can be executed by the database system to create a condition provider procedure that implements row level security using the structured filter. At run time, when a user queries the TEST_CESF_VIEW described above with respect to FIG. 2, the database system can generate a dynamic filter predicate string from the FOR_DYNAMICSF_VIEW permission table by invoking the condition provider procedure. A dynamically generated filter predicate string from the condition provider procedure can be first converted by the database system to a query optimizer predicate and then injected into a query plan and applied to query results.

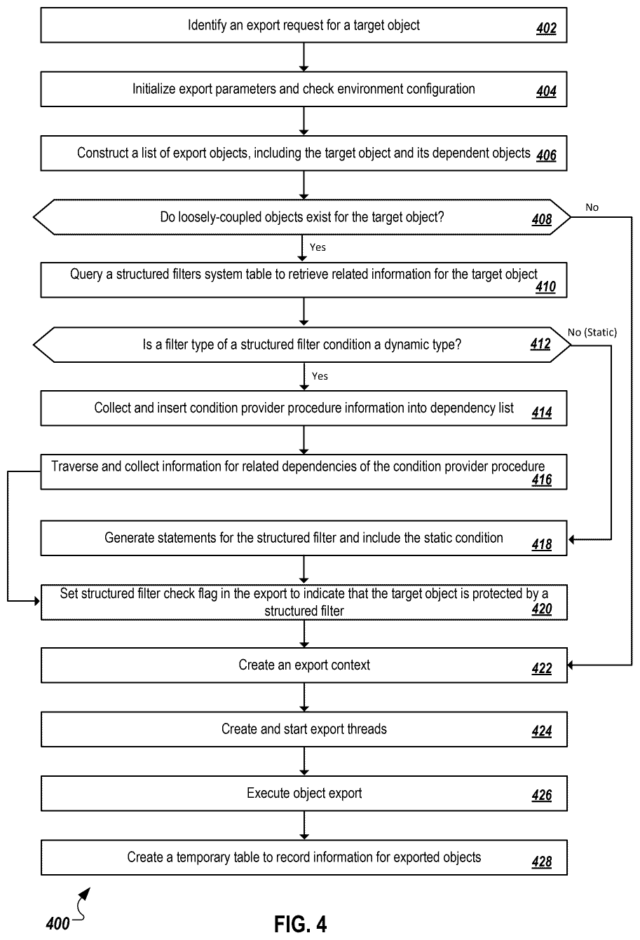

FIG. 4 depicts an example process 400 that can be executed in accordance with implementations of the present disclosure. In some examples, the example process 400 is provided using one or more computer-executable programs executed by one or more computing devices.

An export request is identified for a target object (402). The target object can be exported along with other target objects as part of an export operation, for example. The process 400 can be repeated for each target object included in the overall export operation.

Export parameters are initialized and an export environment configuration is checked (404). When multiple target objects are exported, step 404 may be performed once for the set of multiple objects.

A list of export objects is constructed that includes the target object and dependent objects of the target object (406). The dependent objects can include objects that are tightly-coupled to the target object.

A determination is made as to whether loosely-coupled objects exist for the target object (408). For example, when the target object is a view object, a determination can be made as to whether an attribute flag of the view object indicates that the view object is protected by a structured filter. For instance, in the example of FIG. 2, the attribute flag for the TEST_CESF_VIEW view object may be set for the view object based on the structured filter check clause 212 being included in the create view statement 208. As mentioned above, the structured filter check clause 212 does not indicate which structured filter(s) are associated with the view object.

If loosely-coupled objects, such as structured filter(s) exist for the target object, a structured filters system table is queried to retrieve related information for the target object (410). For instance, for the example of the view TEST_CESF_VIEW, the database system can execute a query of “SELECT*FROM STRUCTURED FILTERS WHERE to_nvarchar(OPERAND)=‘TEST_SCHEMA:TEST_CESF_VIEW’,”.

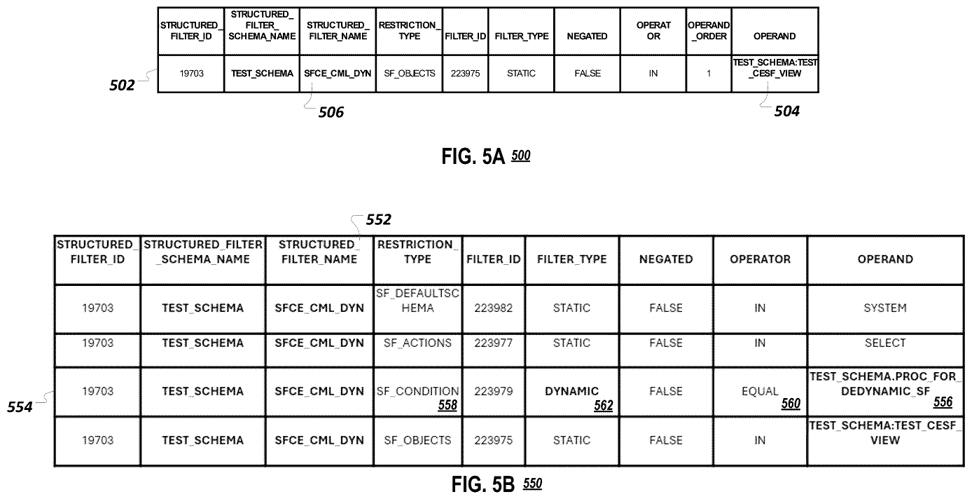

FIG. 5A illustrates example query results 500. The query results 500 are example results that may be generated based on executing the query “SELECT*FROM STRUCTURED_FILTERS WHERE to_nvarchar(OPERAND)=‘TEST_SCHEMA:TEST_CESF_VIEW’,” described above for step 410 of FIG. 4. The query results 500 include a row 502 that has an operand value 504 matching the TEST_CESF_VIEW view name. The database system can extract, from the row 502, a structured filter name 506 of a structured filter associated with the TEST_CESF_VIEW view.

The database system can execute another query against the structured filters table using the extracted structured filter name to retrieved structured filter information for that structured filter. For example, the database system can execute a query of “SELECT*FROM STRUCTURED FILTERS WHERE STRUCTURED_FILTER_NAME=‘SFCE_CML_DYN’,” where the extracted structured filter name is included in a WHERE clause of the query.

FIG. 5B illustrates example query results 550. The query results 550 are example results that may be generated based on executing the query “SELECT*FROM STRUCTURED_FILTERS WHERE STRUCTURED_FILTER_NAME=‘SFCE_CML_DYN’,” described above in the description of FIG. 5A. The query results 550 include result rows that have the structured filter name SFCE_CML_DYN for a STRUCTURED_FILTER_NAME column 552. The database system can extract structured filter information from the result rows. For example, for a row 554, the database system can extract a condition provider procedure name 556 of TEST_SCHEMA.PROC_FOR_DEDYNAMIC_SF from the row 554 based on the row 554 having a RESTRICTION_TYPE value 558 of SF_CONDITION and an OPERATOR value 560 of EQUAL. The database system may execute another query to extract the condition provider procedure name 556, for example. The condition provider procedure name 556 corresponds to the condition provider procedure that can be created by executing the code statement 306 of FIG. 3, for example.

Referring again to FIG. 4, a determination is made, for each retrieved structured filter, as to whether a filter type of the structured filter condition is a dynamic type (412). For instance and referring again briefly to FIG. 5B, the database system can determine that a FILTER_TYPE value 562 for the row 554 is a value of DYNAMIC.

Referring again to FIG. 4, if the filter type of a given structured filter condition is a dynamic type, condition provider procedure information is collected and inserted into a dependency list for the target object (414).

Related dependencies of the condition provider procedure are traversed and information for the related dependencies of the condition provider procedure is collected (416).

If the filter type for a structured filter condition is not a dynamic type (e.g., is a static type), statements are generated for the structured filter that include the static condition (418).

After structured filter information from the system table is processed, a structured filter check flag is set in an export result to indicate that the target object is protected by a structured filter (420).

An export context is created (422).

Export threads are created and started (424).

The object export is executed using the export threads (426).

A temporary table is created and used to record information for exported objects (428).

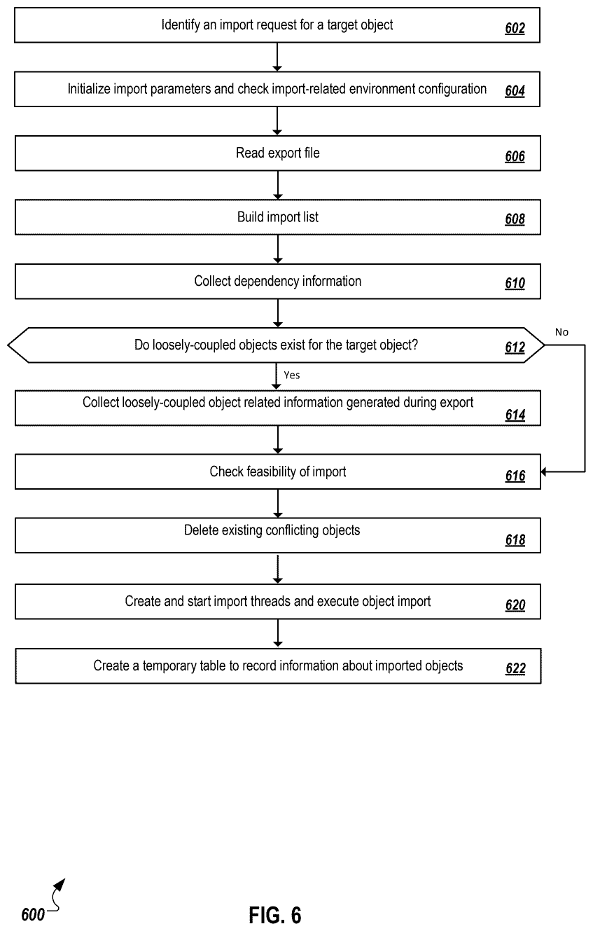

FIG. 6 depicts an example process 600 that can be executed in accordance with implementations of the present disclosure. In some examples, the example process 600 is provided using one or more computer-executable programs executed by one or more computing devices.

An import request is identified for a target object (602). The target object may be included in an export file exported from another system, for example. The export file may include other target objects other than the target object. The process 600 can be repeated for each target object included in the export file.

Import parameters are initialized and import-related environment configuration information is checked (604).

The export file is read (606).

An import list is built based on contents of the export file (608).

Dependency information and other import information is collected (610).

A determination is made as to whether loosely-coupled objects exist for the target object (612). For example, a determination can be made as to whether the export file includes a flag for the target object that indicates that the export file includes information for objects that are loosely coupled to the target object. The flag can be included in the export file during the export process, as described above.

If loosely-coupled objects exist for the target object, loosely-coupled object related information generated during the export is collected (614).

Feasibility of an import operation is checked (616).

Any existing conflicting objects are deleted (618). For example, the database may include the target object and/or a related object and those existing object(s) can be deleted from the database before the import occurs.

Import threads are created, started, and used to perform the import (620).

A temporary table is created and used to record information about imported objects (622).

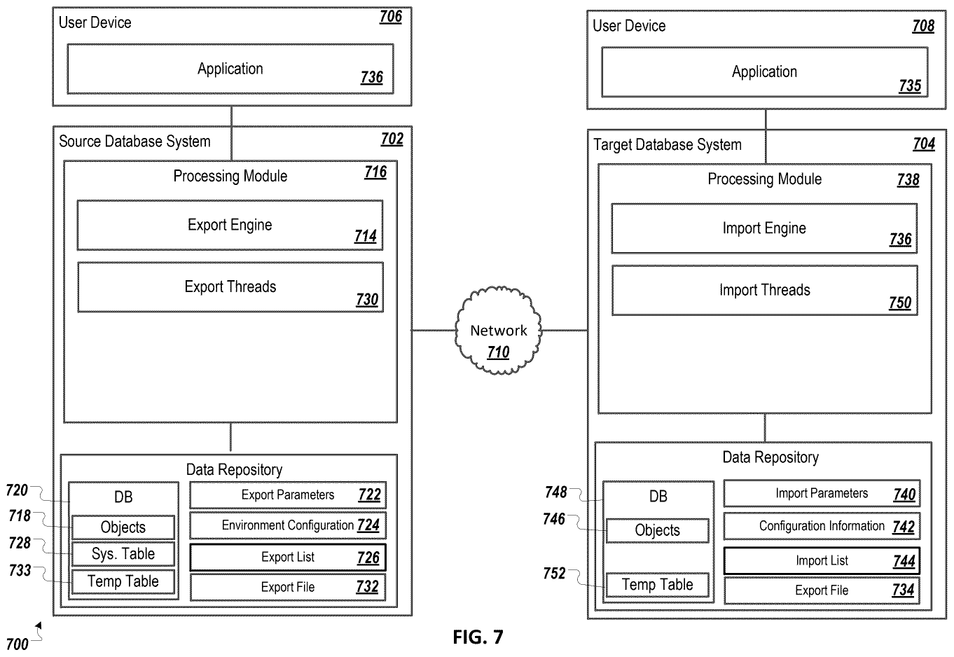

FIG. 7 depicts an example system 700 that can be used to execute implementations of the present disclosure. The system 700 includes a source database system 702, a target database system 704, a client device 706, and a client device 708 communicating over a network 710. In some examples, a user (e.g., an administrator) uses an application 712 on the client device 706 to trigger or request a database export from the source database system 702. In some examples, a database export is automatically triggered, based on an event identified in the source database system 702.

An export engine 714 of a processing module 716 can perform an export operation in response to the data export trigger or request. In some examples, the export engine 714 can identify one or more target data objects to export, such as from the request. The target data object(s) can be database objects 718 included in a database 720 of the source database system 702, for example.

The export engine 714 can initialize export parameters 722 for the export operation and can check environment configuration information 724 before performing the export operation. The export engine 714 can, as part of the export operation, construct an export list 726 of export objects that includes the identified target object(s) and their related (e.g., dependent) objects. As mentioned above, related objects can be tightly-coupled objects or loosely-coupled objects.

The export engine 714 can determine whether a loosely-coupled object exists for a target object. For example, a view object may include an attribute indicating that the view uses a structured filter to implement row-level security for the view. The attribute, while indicating that a structured filter may be used, might not indicate which structured filters are associated with the view. Thus any related structured filters can be considered loosely-coupled to the view since the view definition itself doesn't explicitly link the structured filter to the view.

The export engine 714 can query metadata of the source database system 702 to determine loosely-coupled object information for the target object. For example, for a view target object, the export engine 714 can query a structured filters system table 728 to determine structured filter information for a structured filter that is used by the view. For instance, the export engine 714 can query a system table with a name of STRUCTURED_FILTERS to retrieve related structured filter information such as a restriction type, a filter type, and an operand. If a retrieved restriction type is a dynamic type, the export engine can also collect condition provider procedure information. The export engine 714 can also traverse and collect information for related dependencies of the condition provider procedure. Retrieved structured filter and condition provider procedure information can be appended to the export list 726 for the target object. If a restriction type for a structured filter is a static type, the export engine 714 can generate statements for the structured filters and include statements and the static condition in the export list 726 for the target object. Additionally, when the target object is related to a structured filter, the information for the target object that has been included in the export list 726 can include a flag (e.g., a “STRUCTURED FILTER CHECK” flag) to indicate in the export list 726 that the target object is protected by a structured filter.

The export engine 714 can create an export context and create and start export threads 730 to run in the export context. The export threads 730 can execute an object export to create an export file 732 based on information in the export list 726. For example, the export threads 730 can identify object paths for objects in the export list 726, generate create-object statements, configuration, and object metadata for objects in the export list 726, and include the create statements and configuration and metadata information in the export file 732. The export threads 730 can also create a temporary table 733 and log information about exported objects in the temporary table 733.

The export file 732 can be provided to the target database system 704 for use in an import operation. For example, the administrator can use the application 712 to trigger a sending of the export file 732 to the target database system 704. The target database system 704 can receive the export file 732 as an export file 734, for example. In some examples, a user (e.g., an administrator) uses an application 735 on the client device 708 to trigger the database import. In some examples, the client device 708 is a same device as the client device 706 (e.g., an administrator may use a same device to trigger both an export and an import). In some examples, a database import is automatically triggered, based on determining that the database system 704 has received the export file 734.

In response to the trigger or request to perform a database import using the export file 734, an import engine 736 of a processing module 738 can perform an import operation. For example, the import engine 736 can initialize import parameters 740 and check import-related environment configuration information 742. The import engine 736 can load and read the export file 734. The import engine 736 can build an import list 744 for the import operation. The import engine 736 can build the import list 744 by reading information about exported objects and related/dependent objects in the export file 734. For a given target object, the export file may include information for tightly-coupled related objects and/or loosely-coupled related objects. A loosely-coupled related object can be identified in the export file 734 based on identifying a flag that indicates that a given target object is related to a loosely-coupled object. In response to identification of the flag, the import engine can extract related loosely-coupled object information from the export file and add the loosely-coupled object information to the import list 744. For example, for a view target object, the import engine 736 can extract information for related structured filters, condition provider procedures, conditions, and other related objects from the export file 734 and add that information to the import list 744.

In some examples, the import engine 736 performs a feasibility analysis on the import list 744 to determine whether the import list 744 includes object information for all identified object dependencies. The import engine 736 can also perform queries and perform delete operations on objects 746 in a database 748 for any existing objects in the database 748 that may conflict with objects in the import list 744. The import engine 736 can create and start import threads 750 for performing the object import using the import list 744. For example, the import threads 750 can execute create statements for objects in the import list 744 to create objects in the database 748, e.g., where the create statements can be statements that have been retrieved from the export file 734. The import threads 750 can also create a temporary table 752 for logging results of the import operation.

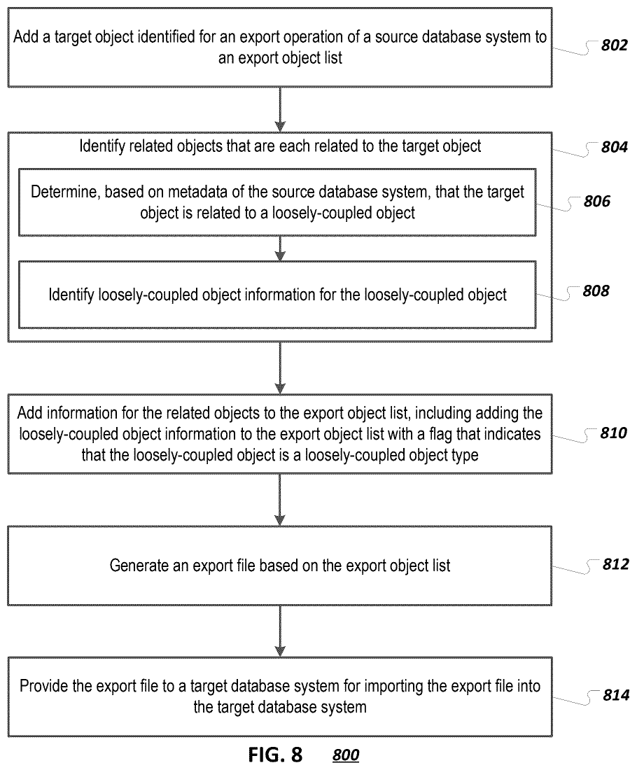

FIG. 8 depicts an example process 800 that can be executed in accordance with implementations of the present disclosure. In some examples, the example process 800 is provided using one or more computer-executable programs executed by one or more computing devices.

At 802, a target object identified for an export operation of a source database system is added to an export object list.

At 804, related objects are identified that are each related to the target object.

At 806, identifying the related objects includes determining, based on metadata of the source database system, that the target object is related to a loosely-coupled object that is not explicitly linked to the target object in a definition of the target object. For example, the target object can be a database view and the loosely-coupled object can be a structured filter that provides row-level security for the database view. A structured filters system table of the source database system can be queried to determine that the structured filter is related to the target object.

At 808, loosely-coupled object information is determined for the loosely-coupled object. Determining the loosely-coupled object information can include: determining that a filter type of a structured filters condition of the structured filter is a dynamic type; identifying a condition provider procedure related to the structured filter; collecting condition provider procedure information for the condition provider procedure; and including the condition provider procedure information in the loosely-coupled object information. Collecting condition provider procedure information for the condition provider procedure can include collecting object information for related objects of the condition provider procedure and including the object information for the related objects of the condition provider procedure in the loosely-coupled object information. Determining the loosely-coupled object information can include: determining that a filter type of a structured filters condition of the structured filter is a static type and including static condition information for the structured filter in the loosely-coupled object information.

At 810, information for the related objects is added to the export object list. The loosely-coupled object information can be added to the export object list with a flag that indicates that the loosely-coupled object is a loosely-coupled object type. The related objects can include a tightly-coupled object that is explicitly linked to the target object in the definition of the target object. The information for the related objects can include database statements for creating the related objects in the target database system.

At 812, an export file is generated based on the export object list. The export file can include information for other target objects other than the target object.

At 814, the export file is provided to a target database system for importing the export file into the target database system.

The target database system can receive the export file. The target database system can generate an object import list based on the export file. Generating the object import list can include: identifying the target object in the export file; gathering related object information for the target object, including identifying the loosely-coupled object as a related object of the target object; identifying, in the export file, the flag that indicates that the loosely-coupled object is a loosely-coupled object type; and based on identifying the flag, extracting the loosely-coupled object information for the loosely-coupled object and objects related to the loosely-coupled object. The target database system can execute a database import at the target database system using information in the object import list. Executing the database import can include executing database commands, in a dependency order, in the target database system, to create objects related to the loosely-coupled object, the loosely-coupled object, and the target object. In some examples, the target database system can delete, in the target database system, before executing the database commands, any existing conflicting objects that conflict with the target object or related objects of the target object.

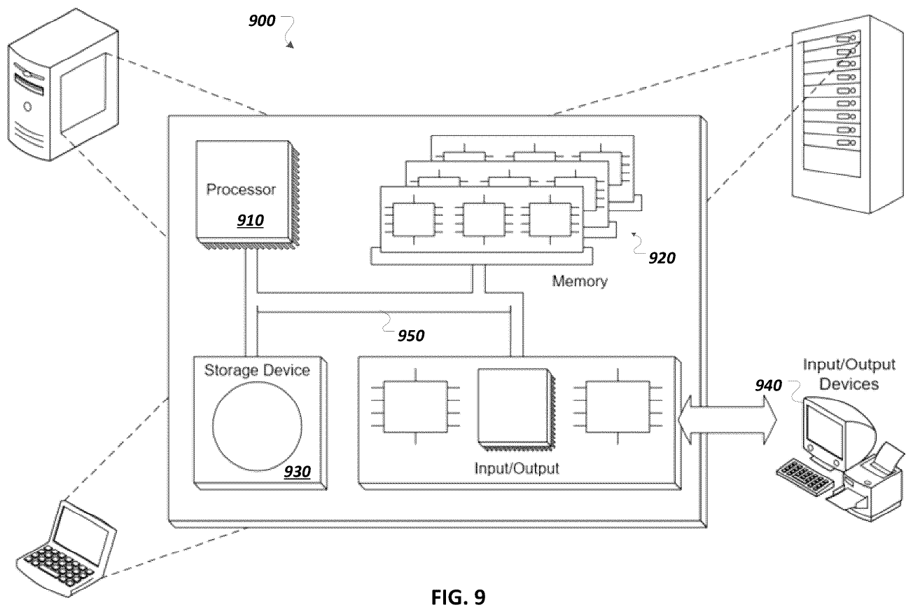

Referring now to FIG. 9, a schematic diagram of an example computing system 900 is provided. The system 900 can be used for the operations described in association with the implementations described herein. For example, the system 900 may be included in any or all of the server components discussed herein. The system 900 includes a processor 910, a memory 920, a storage device 930, and an input/output device 940. The components 910, 920, 930, 940 are interconnected using a system bus 950. The processor 910 is capable of processing instructions for execution within the system 900. In some implementations, the processor 910 is a single-threaded processor. In some implementations, the processor 910 is a multi-threaded processor. The processor 910 is capable of processing instructions stored in the memory 920 or on the storage device 930 to display graphical information for a user interface on the input/output device 940.

The memory 920 stores information within the system 900. In some implementations, the memory 920 is a computer-readable medium. In some implementations, the memory 920 is a volatile memory unit. In some implementations, the memory 920 is a non-volatile memory unit. The storage device 930 is capable of providing mass storage for the system 900. In some implementations, the storage device 930 is a computer-readable medium. In some implementations, the storage device 930 may be a floppy disk device, a hard disk device, an optical disk device, or a tape device. The input/output device 940 provides input/output operations for the system 900. In some implementations, the input/output device 940 includes a keyboard and/or pointing device. In some implementations, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

1. A computer-implemented method comprising:
adding a target object identified for an export operation of a source database system to an export object list;
identifying all related objects that are each related to the target object in the source database system, wherein identifying the related objects includes:
querying a system table of the source database system to identify metadata of the source database system for identifying related objects;
determining, based on the metadata of the source database system, that the target object is related to a loosely-coupled object that is not explicitly linked to the target object in a definition of the target object; and
identifying loosely-coupled object information for the loosely-coupled object;
adding information for the related objects to the export object list, including adding the loosely-coupled object information to the export object list with a flag that indicates that the loosely-coupled object is a loosely-coupled object type;
generating an export file based on the export object list; and
providing the export file to a target database system for importing the export file into the target database system.

2. The computer-implemented method of claim 1, wherein the target object is a database view and the loosely-coupled object is a structured filter that provides row-level security for the database view.

3. The computer-implemented method of claim 2, wherein determining, based on the metadata of the source database system, that the target object is related to the loosely-coupled object comprises querying a structured filters system table of the source database system to determine that the structured filter is related to the target object.

4. The computer-implemented method of claim 3, wherein determining the loosely-coupled object information comprises:
determining that a filter type of a structured filters condition of the structured filter is a dynamic type;
identifying a condition provider procedure related to the structured filter;
collecting condition provider procedure information for the condition provider procedure; and
including the condition provider procedure information in the loosely-coupled object information.

5. The computer-implemented method of claim 4, wherein collecting condition provider procedure information for the condition provider procedure comprises collecting object information for related objects of the condition provider procedure and including the object information for the related objects of the condition provider procedure in the loosely-coupled object information.

6. The computer-implemented method of claim 3, wherein determining the loosely-coupled object information comprises:
determining that a filter type of a structured filters condition of the structured filter is a static type; and
including static condition information for the structured filter in the loosely-coupled object information.

7. The computer-implemented method of claim 1, wherein the related objects include a tightly-coupled object that is explicitly linked to the target object in the definition of the target object.

8. The computer-implemented method of claim 1, wherein the information for the related objects includes database statements for creating the related objects in the target database system.

9. The computer-implemented method of claim 1, wherein the export file includes information for other target objects other than the target object.

10. The computer-implemented method of claim 1, further comprising:
receiving, at the target database system, the export file;
generating an object import list based on the export file, wherein generating the object import list comprises:
identifying the target object in the export file;
gathering related object information for the target object, including identifying the loosely-coupled object as a related object of the target object;
identifying, in the export file, the flag that indicates that the loosely-coupled object is a loosely-coupled object type; and
based on identifying the flag, extracting the loosely-coupled object information for the loosely-coupled object and objects related to the loosely-coupled object.

11. The computer-implemented method of claim 10, further comprising executing a database import at the target database system using information in the object import list.

12. The computer-implemented method of claim 11, wherein executing the database import comprises executing database commands, in a dependency order, in the target database system, to create objects related to the loosely-coupled object, the loosely-coupled object, and the target object.

13. The computer-implemented method of claim 12, further comprising deleting, in the target database system, before executing the database commands, any existing conflicting objects that conflict with the target object or related objects of the target object.

14. A system comprising:
one or more computers; and
a computer-readable medium coupled to the one or more computers having instructions stored thereon which, when executed by the one or more computers, cause the one or more computers to perform operations comprising:
adding a target object identified for an export operation of a source database system to an export object list;
identifying all related objects that are each related to the target object in the source database system, wherein identifying the related objects includes:
querying a system table of the source database system to identify metadata of the source database system for identifying related objects;
determining, based on the metadata of the source database system, that the target object is related to a loosely-coupled object that is not explicitly linked to the target object in a definition of the target object; and
identifying loosely-coupled object information for the loosely-coupled object;
adding information for the related objects to the export object list, including adding the loosely-coupled object information to the export object list with a flag that indicates that the loosely-coupled object is a loosely-coupled object type;
generating an export file based on the export object list; and
providing the export file to a target database system for importing the export file into the target database system.

15. The system of claim 14, wherein the target object is a database view and the loosely-coupled object is a structured filter that provides row-level security for the database view.

16. The system of claim 15, wherein determining, based on the metadata of the source database system, that the target object is related to the loosely-coupled object comprises querying a structured filters system table of the source database system to determine that the structured filter is related to the target object.

17. The system of claim 14, wherein the export file includes information for other target objects other than the target object.

18. A computer program product encoded on a non-transitory storage medium, the product comprising non-transitory, computer readable instructions for causing one or more processors to perform operations comprising:
adding a target object identified for an export operation of a source database system to an export object list;
identifying all related objects that are each related to the target object in the source database system, wherein identifying the related objects includes:
querying a system table of the source database system to identify metadata of the source database system for identifying related objects;
determining, based on the metadata of the source database system, that the target object is related to a loosely-coupled object that is not explicitly linked to the target object in a definition of the target object; and
identifying loosely-coupled object information for the loosely-coupled object;
adding information for the related objects to the export object list, including adding the loosely-coupled object information to the export object list with a flag that indicates that the loosely-coupled object is a loosely-coupled object type;
generating an export file based on the export object list; and
providing the export file to a target database system for importing the export file into the target database system.

19. The computer program product of claim 18, wherein the target object is a database view and the loosely-coupled object is a structured filter that provides row-level security for the database view.

20. The computer program product of claim 19, wherein determining, based on the metadata of the source database system, that the target object is related to the loosely-coupled object comprises querying a structured filters system table of the source database system to determine that the structured filter is related to the target object.
